(19) United States
(12) Patent Application Publication
(10) Pub. No.: US 2026/0046291 A1
(43) Pub. Date: Feb. 12, 2026

(54) SYSTEM AND METHOD FOR MULTI LEVEL, USER CONTROLLED VERIFICATION AND CONTEXT SPECIFIC CREDENTIAL SHARING

(71) Applicants: Deepak Ahuja, Bothell, WA (US); Manisha Ahuja, BOTHELL, WA (US); Saisha Ahuja, Bothell, WA (US); Devansh Ahuja, Bothell, WA (US)

(72) Inventors: Deepak Ahuja, Bothell, WA (US); Manisha Ahuja, BOTHELL, WA (US); Saisha Ahuja, Bothell, WA (US); Devansh Ahuja, Bothell, WA (US)

(21) Appl. No.: 19/291,670

(22) Filed: Aug. 6, 2025

(51) Int. Cl. H04L 9/40

(52) U.S. Cl. CPC H04L 63/102; H04L 63/0838

(57) ABSTRACT

A computer-implemented system performs multi-level, user-initiated verification and selective credential sharing. A verification server issues secure API calls to multiple external providers to verify user-selected categories, including identity, employment, financial, education, criminal, court, family, social media, and medical. Provider data is normalized to a common schema, and fallback procedures are applied if primary verification fails. Verified results are stored in a user-controlled credential wallet. The wallet enables creation of share profiles specifying subsets of categories for disclosure in different contexts, each with configurable time limits, revocation rights, and access controls. Secure links or machine-readable codes provide recipient access to only the authorized categories. An immutable audit log records verification events, share profile creation, recipient access, and revocation, enabling compliance and evidentiary tracking while protecting personal data.

### FIELD OF THE INVENTION

The present invention relates generally to digital verification systems and methods for authenticating personal information in online and network-connected environments. More particularly, this invention pertains to an automated, multi-level, user-initiated verification and credential sharing platform that fundamentally shifts control from institutions to individuals, enabling users to:
1. Proactively verify multiple categories of personal credentials—including government-issued identity information, employment history, financial standing, educational achievements, social media ownership, legal and court records, family and relationship background, and medical history—through orchestrated integration of multiple independent data sources via secure application programming interfaces (APIs), preferably using GraphQL for selective field retrieval; and
2. Selectively share configurable subsets of verified results with other individuals or entities through context-specific share profiles, protected by two-factor authentication for recipients, enabling users to demonstrate authenticity and establish credibility while maintaining complete control over their sensitive data.

The invention provides a unified verification and context-aware controlled sharing framework featuring innovative technical capabilities:
Parallel or sequential verification operations across heterogeneous third-party services with intelligent orchestration determining optimal execution order;
Sophisticated data normalization and correlation engine that transforms disparate formats (JSON, XML, CSV) into a common, machine-readable schema with fuzzy matching and entity recognition;
Four-tier consent management architecture exceeding typical privacy requirements, capturing initial verification consent, storage consent, sharing consent, and recipient usage consent;
Composite scoring methodology combining weighted scores, confidence intervals, correlation factors, and reliability indices for nuanced verification assessments;
Multi-layer fallback mechanisms (secondary APIs, document upload with OCR, manual verification) ensuring high completion rates;
User-controlled credential wallet with AES-256 encryption at rest, supporting granular, time-limited, and immediately revocable sharing through secure links, QR codes, or embedded badges;
Two-factor authentication for recipients using OTP verification to pre-registered contact methods;

While applicable to various trust-sensitive domains including employment screening, tenant vetting, peer-to-peer marketplaces, and financial services onboarding, the invention is particularly suited to the online dating and relationship matching industry. In this context, the platform enables users to build trust progressively through phased disclosure—initially sharing basic verification (identity, family background, employment) and later expanding access as mutual trust develops. This user-controlled approach allows individuals to establish credibility before meeting, without surrendering control to any platform or permanently exposing sensitive information.

### BACKGROUND OF THE INVENTION

Traditional identity and background verification systems suffer from a fundamental architectural flaw: they are designed for institutional control rather than individual empowerment. In conventional models, organizations initiate verification processes where individuals are passive subjects with no control over their data. An employer runs background checks, a landlord requests credit reports, or a financial institution pulls bureau data—in each case, the verified individual has no persistent record of their verification, no control over sharing, and must repeatedly undergo the same checks for different purposes. This institutional-centric approach creates inefficiency, privacy risks, and user frustration.

The technical challenges in current verification systems are substantial and multifaceted. Different verification providers return data in incompatible formats—one service might provide dates as “MM/DD/YYYY” in JSON, another as “YYYY-MM-DD” in XML, and a third as “DD-MMM-YYYY” in CSV. Field naming conventions vary wildly: “employer_name,” “companyName,” and “business.name” might all represent the same data point. Without sophisticated normalization, accurate information appears contradictory, causing false verification failures. Current systems lack intelligent correlation—they cannot recognize that “Acme Inc.,” “ACME INCORPORATED,” and “Acme Corp”likely represent the same entity.

Existing verification services also suffer from poor resilience and limited coverage. When a primary verification source fails—whether due to technical issues, data gaps, or simple name variations—most systems simply return failure with no alternative path. If an employment verification API doesn't cover a particular employer, or if an identity verification service has outdated records, users face dead ends. This lack of intelligent fallback mechanisms results in legitimate users being unable to verify their information, forcing manual interventions that delay processes by days or weeks.

The online dating industry exemplifies these limitations most acutely. Dating platforms typically offer minimal verification—perhaps photo matching or phone number confirmation—that fails to establish meaningful trust. Users cannot prove their employment, education, or background without revealing excessive personal information. More critically, any verification performed within a dating app remains trapped in that platform's silo. Users cannot port their verified credentials to other platforms or share them selectively with potential matches. This forces users to choose between remaining anonymous (and appearing potentially fraudulent) or over-sharing sensitive information without control.

Current approaches to consent and data sharing are equally problematic. Most verification systems implement binary consent—either full access or no access—without granular control. Users cannot share their employment verification while keeping financial information private, or reveal their education credentials without exposing criminal background checks. Time-based access control is virtually non-existent; once information is shared, it typically remains accessible indefinitely. Revocation mechanisms, if they exist at all, are cumbersome and unreliable.

The technical infrastructure for verification sharing is primitive. Systems lack secure, authenticated methods for transmitting verification results to third parties. Recipients have no way to verify the authenticity of shared credentials. Audit trails are minimal or non-existent, providing no evidence of who accessed what information when. This absence of cryptographically secure, tamper-evident logging makes it impossible to track data usage or investigate breaches.

Perhaps most critically, existing systems fail to implement progressive disclosure models that match how trust naturally develops in human relationships. In dating contexts, individuals might initially want to verify basic identity and employment, then gradually share more detailed background information as relationships develop. Current all-or-nothing verification models cannot support this nuanced, context-aware sharing that respects both privacy and the need for progressive trust building.

What is urgently needed is a paradigm shift from institution-controlled to user-controlled verification, implemented through a technically sophisticated platform that addresses these multifaceted challenges. Such a system must provide comprehensive verification across multiple categories, intelligent normalization and correlation of heterogeneous data sources, resilient multi-layer fallback mechanisms, cryptographically secure storage with user control, granular and revocable sharing with proper authentication, context-aware disclosure profiles, and audit trails for accountability. This invention provides exactly such a solution, fundamentally reimagining how personal verification should work in the digital age.

### SUMMARY OF THE INVENTION

The invention provides a multi-level, user-controlled verification and credential sharing system that fundamentally transforms how personal information is verified, stored, and shared. Unlike conventional verification systems where institutions initiate checks on passive subjects, this invention empowers individuals to proactively verify their own credentials across nine comprehensive categories—identity verification, employment verification, financial status, education credentials, family and relationship background, social media ownership, criminal background checks, court records, and medical history—through a single unified platform. The system comprises a verification orchestration server 104 featuring a verification workflow engine 106, an API integration layer 108 (preferably using GraphQL for selective field retrieval), a 4-tier consent management component, a credential wallet database 112 with AES-256 encryption, and an audit log 114.

A critical innovation is the sophisticated data normalization and correlation engine (illustrated in FIG. 6) that addresses the significant challenge of heterogeneous data formats across verification providers. The system transforms raw data arriving in various formats (JSON, XML, CSV) with inconsistent field names (“employer_name,” “companyName,” “business.name”) into a unified schema through intelligent field mapping, format standardization (dates to ISO 8601, phones to E.164), and fuzzy string matching that recognizes entity equivalence (“Acme Inc.”≈“ACME INC.”≈“Acme Incorporated”). The correlation engine calculates confidence scores and identifies relationships between data points from multiple sources, producing normalized output with correlation scores essential for accurate verification.

The system implements a multi-layer fallback architecture (detailed in FIG. 2) with three distinct levels to maximize verification success rates. Level 1 fallbacks attempt verification through secondary APIs or alternative providers when primary sources fail. Level 2 fallbacks request documentary evidence from users (pay stubs, tax documents, official letters) for OCR processing and analysis. Level 3 fallbacks may initiate manual verification processes, such as contacting employers or educational institutions. This intelligent fallback system operates automatically with user consent, ensuring legitimate users aren't penalized by coverage gaps in any single provider.

The invention introduces a comprehensive four-tier consent architecture (illustrated in FIG. 9) that provides unprecedented user control and legal protection. Tier 1 captures initial verification consent with explicit authorization for each category. Tier 2 obtains storage consent for retention in the encrypted credential wallet. Tier 3 manages sharing consent for each disclosure instance. Tier 4, a novel addition, requires recipients to acknowledge data limitations and agree not to base decisions solely on the verification data. This multi-layered consent framework exceeds typical privacy requirements while maintaining usability.

A distinctive feature is the user-controlled credential wallet supporting context-aware selective sharing through customizable share profiles. Users can create profiles for specific contexts—dating (sharing identity, family, employment), employment screening (adding education and criminal history), or tenancy applications (focusing on financial stability). Each profile supports granular controls including detail level selection (summary vs. detailed), time-based expiration (default 30 days, user-configurable), and immediate revocation capabilities. The system implements two-factor authentication for recipients (shown in FIG. 8), requiring OTP verification sent to pre-registered contact methods before granting access, significantly enhancing security beyond simple link-based sharing.

The platform employs a sophisticated composite scoring methodology (depicted in FIG. 7) combining four distinct approaches: weighted composite scoring based on provider reliability (government databases: 0.9, commercial sources: 0.7), confidence interval scoring with probabilistic ranges (e.g., 92% confidence with 87-97% range), multi-factor correlation scoring that increases confidence when multiple sources agree, and source reliability indexing based on historical accuracy patterns. This nuanced scoring system provides transparent, reliable assessments beyond simple pass/fail determinations.

All system activities are recorded in an audit log (illustrated in FIG. 5). Each log entry contains a cryptographic hash of the previous entry, creating a tamper-evident chain. The system captures comprehensive metadata including microsecond-precision timestamps, detailed access tracking (which categories viewed, duration, device information), and complete lifecycle documentation from share creation through access to revocation. This audit infrastructure provides legally admissible evidence trails while enabling continuous security monitoring for suspicious patterns.

In summary, the invention advances the state of the art through six key innovations: (1) user-initiated comprehensive verification replacing institution-centric models, (2) sophisticated normalization enabling accurate multi-source correlation, (3) intelligent multi-layer fallbacks maximizing success rates, (4) four-tier consent architecture providing complete user control, (5) context-aware selective sharing with two-factor recipient authentication, and (6) audit logging ensuring accountability. The modular architecture supports extension to new verification categories and providers while maintaining the core benefits of user empowerment, privacy protection, and trustworthy verification across all applications from dating to employment to financial services.

### BRIEF DESCRIPTION OF THE ACCOMPANYING DRAWINGS

The aforesaid as well as other objects and advantages of the invention will appear hereinafter from the following description taken in connection with the accompanying drawings in which:

FIG. 1 is a system architecture diagram illustrating an exemplary configuration of the multi-level, user-controlled verification and credential sharing platform. The diagram shows a user device 102 in communication with a verification orchestration server 104. The server includes a verification workflow engine 106, an API integration layer 108 (with GraphQL preferred, REST/SOAP supported), a 4-tier consent management component, external verification providers 110 (identity, employment, financial, education, criminal background, and other categories), a credential wallet database 112 with encrypted storage (AES-256 at rest) and context-specific share profiles, and an audit log 114 with append-only structure and cryptographic hash chain. The system also includes a recipient access interface 116 with 2FA protection for authorized third-party access via secure links or QR codes.

FIG. 2 is a flowchart illustrating the multi-level verification workflow with intelligent fallback mechanisms. The process shows user category selection 202 from nine options, explicit Tier 1 consent capture 203, orchestration engine 204 determining parallel or sequential execution, primary API calls with data normalization, and a comprehensive multi-layer fallback system 205. Level 1 fallbacks use secondary APIs, Level 2 requests document uploads for OCR processing, and Level 3 initiates manual verification. The workflow includes composite scoring methodology 206, Tier 2 storage consent, and continuous audit logging throughout all verification attempts.

FIG. 3 is a flow diagram illustrating the context-specific share profile creation 301 and sharing process. The diagram details profile configuration 302 with contextual labeling, category selection with detail level options (summary/detailed/custom), sharing parameter configuration 303 including time validity and recipient specification, cryptographic token generation 304 with embedded parameters, and the complete recipient authentication flow 306 including OTP verification and Tier 4 usage consent 307 before credential access.

FIG. 4 is an enhanced credential wallet user interface diagram showing the verified credentials dashboard 401 with visual status indicators 402 (✓ for verified, [symbol] for pending,—for not verified), toggle controls and detail level selectors for each category, share profile management 403 with expiration settings, and a recent activity viewer displaying timestamped audit log entries 404 for transparency and user control.

FIG. 5 is a comprehensive flow diagram of the audit logging and access revocation system. The diagram illustrates audit structure with detailed logging of share creation, comprehensive recipient access tracking including viewing behavior, immediate revocation capabilities with session termination, continuous security monitoring, and compliance reporting features.

FIG. 6 is a data normalization and correlation process diagram showing the transformation of heterogeneous raw data from multiple providers (JSON, XML, CSV formats) through field mapping, format standardization, and intelligent string matching into a unified schema with correlation scores and confidence levels.

FIG. 7 is a composite scoring methodology diagram illustrating the four-component scoring system: weighted composite scoring 702 with provider reliability weights, confidence interval scoring 703 with probabilistic ranges, multi-factor correlation scoring 704 based on source agreement, and source reliability indexing 705 from historical performance, all combined through a weighted algorithm producing category and overall scores 707.

FIG. 8 is a two-factor recipient authentication flow diagram detailing the security process where User A specifies recipient contact information, the system validates shared links, sends OTP to pre-registered contacts, verifies recipient identity, and grants access only after successful authentication, with comprehensive failure handling and owner notifications.

FIG. 9 is a four-tier consent architecture diagram illustrating the complete consent framework: Tier 1 initial verification consent with provider and data disclosure, Tier 2 storage consent with encryption and retention options, Tier 3 sharing consent with scope and duration controls, and Tier 4 usage consent requiring recipient acknowledgment of data limitations, all events recorded in the audit log for compliance.

### DETAILED DESCRIPTION OF THE INVENTION

### Overview of the System Architecture

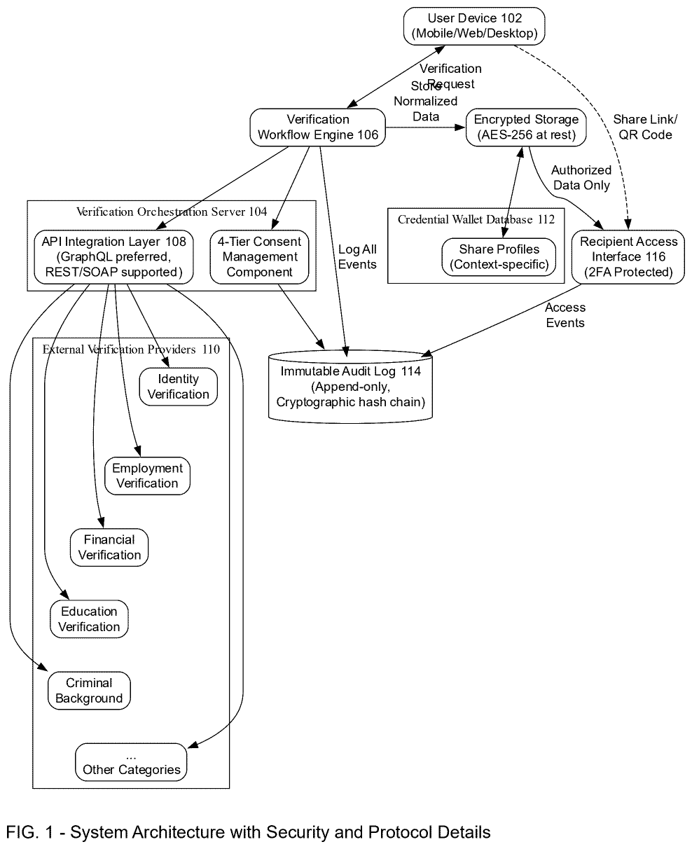

The present invention provides a comprehensive system and method for user-initiated, multi-level personal information verification with selective, context-aware credential sharing capabilities. Unlike conventional verification systems where institutions initiate checks on passive subjects, this invention empowers individuals to proactively verify their own credentials across multiple categories and maintain complete control over how, when, and with whom these verified credentials are shared. The system architecture, illustrated in FIG. 1, comprises several key components working in concert to achieve this user-centric verification and sharing paradigm.

Referring to FIG. 1, the system includes a user device 102 (which may be a smartphone, tablet, computer, or other network-connected device) that communicates with a verification orchestration server 104. The server 104 comprises multiple integrated modules: a verification workflow engine 106 that coordinates and manages the entire verification process across multiple categories; an API integration layer 108 (with GraphQL preferred, REST/SOAP supported) that interfaces with numerous external verification providers 110 including identity verification, employment verification, financial verification, education verification, criminal background, and other categories; a 4-tier consent management component that handles all consent operations; a credential wallet database 112 containing encrypted storage (AES-256 at rest) and share profiles (context-specific); and an audit log 114 (append-only, cryptographic hash chain) that maintains tamper-proof records of all verification and sharing events. The system further includes a recipient access interface 116 (2FA protected) that enables authorized third parties to view user-selected portions of verification data through secure access mechanisms.

The API integration layer 108 implements a flexible architecture that can utilize various protocols for communication with external providers. In one preferred embodiment, the layer employs GraphQL as the query language, which provides particular technical advantages for selective field retrieval. This architectural choice enables the system to request only specific data fields from verification providers, minimizing data exposure and supporting the invention's privacy-by-design principles. The GraphQL implementation allows dynamic query construction based on user consent and share profile configurations, ensuring that data requests align precisely with user-authorized disclosures. However, the invention is not limited to GraphQL and may alternatively use REST APIs, SOAP protocols, or other suitable communication mechanisms.

### Multi-Category Verification Framework

The invention supports verification across nine primary categories, though the modular architecture allows for expansion to additional categories without disrupting existing functionality. The supported verification categories include: (1) government-issued identity verification, confirming name, date of birth, address, and identification numbers; (2) employment verification, validating current and past employment, job titles, income ranges, and employment dates; (3) financial verification, assessing credit scores, financial stability indicators, investments, debts and debt-to-income ratios; (4) education verification, confirming degrees, certifications, and institutional attendance; (5) criminal background verification, checking for criminal records, arrests, and convictions; (6) court records verification, reviewing civil litigation, bankruptcies, and liens; (7) family and relationship verification, confirming marital status, family connections, and relationship history; (8) social media ownership verification, validating control of social media accounts and online presence; and (9) medical history verification, confirming health-related information when explicitly authorized by the user.

Each verification category operates through a standardized workflow while accommodating category-specific requirements. The verification workflow engine 106 orchestrates these operations, determining whether categories can be processed in parallel (for independent verifications like identity and education) or must be processed sequentially (when one verification depends on results from another, such as employment verification requiring confirmed identity). This intelligent orchestration reduces overall verification time while maintaining data integrity and accuracy.

### Data Normalization and Correlation Engine

A critical innovation of the present invention is its sophisticated data normalization and correlation engine, which addresses the significant challenge of inconsistent data formats across different verification providers. External verification services return data in widely varying formats, with different field names, data types, confidence scoring models, and even character encodings. Without proper normalization, accurate data from different sources may appear contradictory, leading to false verification failures.

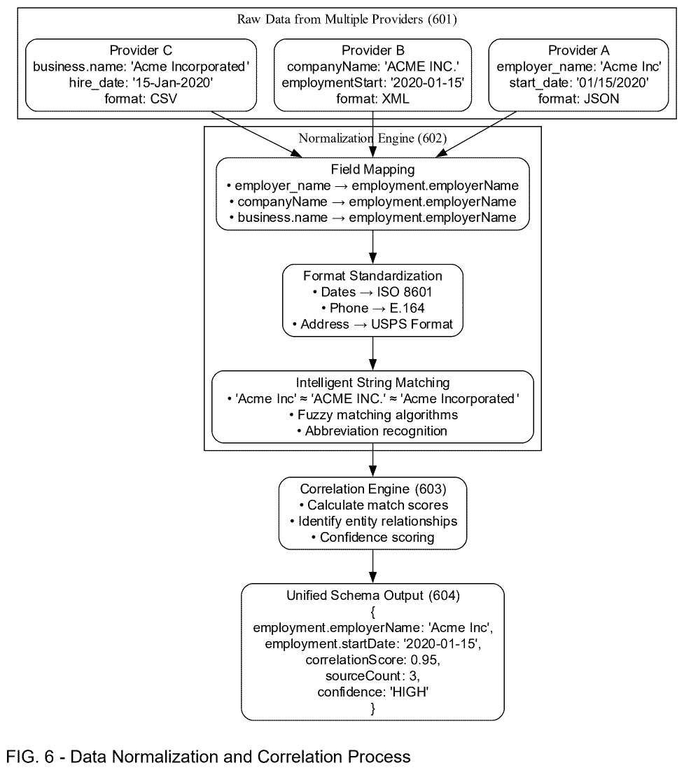

FIG. 6 illustrates the data normalization and correlation process in detail. Raw data arrives from multiple providers 601 in heterogeneous formats—Provider A might send JSON with “employer_name” and dates in MM/DD/YYYY format, Provider B might send XML with “companyName” and dates in YYYY-MM-DD format, while Provider C might send CSV with “business.name”and dates in DD-MMM-YYYY format.

The normalization engine 602 performs multiple operations on incoming data. First, it maps provider-specific field names to a unified schema. For example, one provider might return “employer_name” while another returns “companyName” and a third returns “business.name”—all are mapped to a standardized “employment.employerName” field in the common schema. Second, the engine standardizes data formats, converting dates to ISO 8601 format, normalizing phone numbers to E.164 format, and standardizing addresses according to postal service conventions. Third, it performs intelligent string matching to reconcile minor variations, recognizing that “Acme Inc.”, “Acme Incorporated”, and “ACME INC”likely represent the same entity.

The correlation engine 603 goes beyond simple normalization to identify relationships between data points from different sources. When multiple providers return information about the same entity (such as an employer), the engine calculates match scores, identifies entity relationships, and assigns confidence levels, producing unified schema output 604 with correlation scores and source counts.

### Composite Verification Scoring Methodology

The system implements a sophisticated composite scoring methodology that combines four distinct approaches to generate reliable confidence scores for each verification category and the overall verification profile. This multi-faceted scoring system provides nuanced assessments that go beyond simple pass/fail determinations.

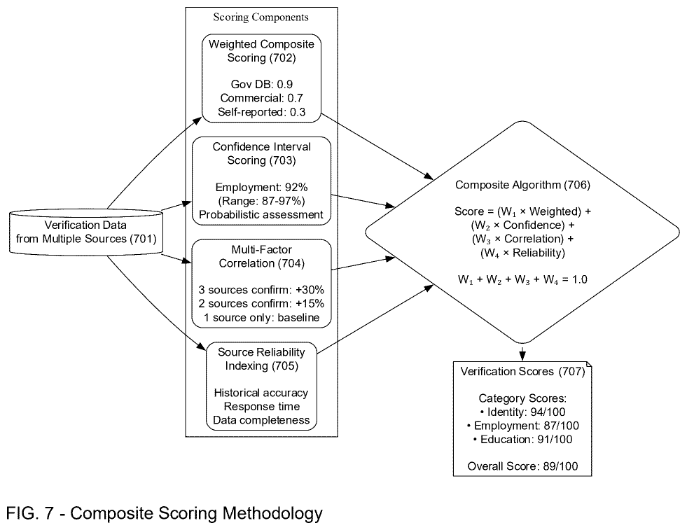

FIG. 7 provides a visual representation of the composite scoring methodology. Verification data from multiple sources 701 feeds into four distinct scoring components.

The first component is weighted composite scoring 702, where different verification sources receive different weights based on their historical reliability and data quality. For instance, verification data from government databases might receive a weight of 0.9, while data from commercial aggregators might receive 0.7 and Self-reported might receive 0.3. The system maintains a dynamic reliability index for each provider, adjusted based on accuracy patterns observed over time.

The second component employs confidence interval scoring 703, generating probabilistic assessments with defined confidence ranges. Rather than stating “employment verified” with absolute certainty, the system might indicate “employment verified with 92% confidence (range: 87-97%)”. This approach acknowledges the inherent uncertainty in verification processes and provides users and recipients with transparent assessments of data reliability.

The third component utilizes multi-factor correlation scoring 704, where verification confidence increases when multiple independent sources corroborate the same information. If three different providers confirm the same employment information through different data sources (payroll records, tax filings, and HR databases), the correlation score increases significantly compared to single-source verification.

The fourth component implements source reliability indexing, maintaining historical accuracy metrics for each provider and data type. The system tracks patterns such as a provider's accuracy rate for different types of verifications, response times, and data completeness. These metrics feed into the overall scoring algorithm, automatically adjusting weights and confidence calculations based on observed performance.

These four scoring components are combined through a weighted algorithm that produces both category-specific scores and an overall verification score. The algorithm is expressed as:
CompositeScore=(W₁×WeightedScore)+(W₂×ConfidenceScore)+(W₃×CorrelationScore)+(W₄×ReliabilityScore)
Where W₁ through W₄ are dynamically adjusted weights that sum to 1.0, and each component score is normalized to a 0-100 scale.

### Multi-Layer Fallback Verification Architecture

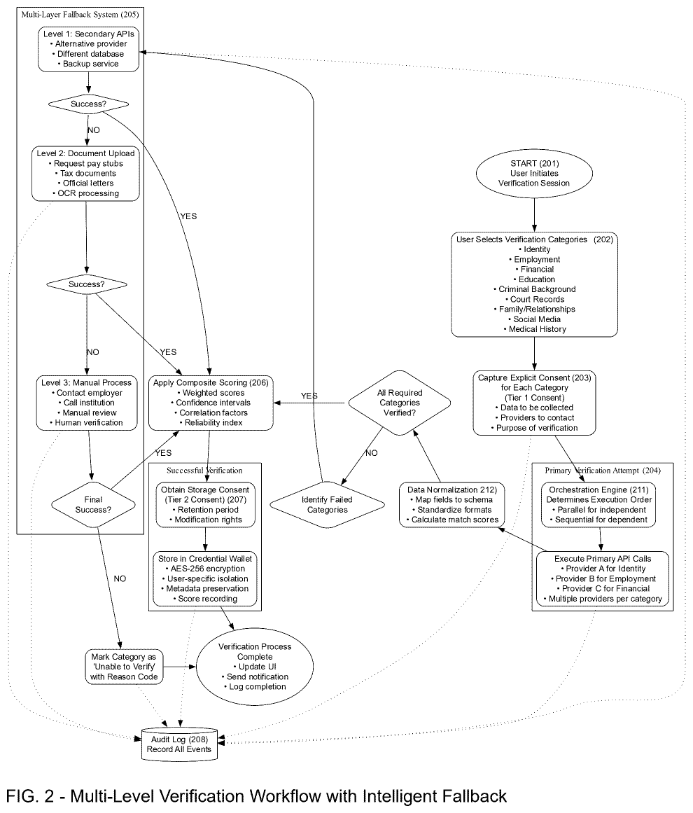

A distinguishing feature of the invention is its intelligent multi-layer fallback architecture, illustrated in the verification workflow of FIG. 2. This architecture ensures high verification completion rates even when primary verification methods fail or return inconclusive results. The fallback system operates automatically based on predefined rules and user consent, minimizing manual intervention while maximizing verification success.

Referring to FIG. 2, the verification workflow begins when a user initiates a verification session 201 through their device. The user selects 202 one or more verification categories from the nine available options: identity, employment, financial, education, criminal background, court records, family/relationships, social media, and medical history. The system then captures explicit consent for each category (Tier 1 Consent) 203, documenting the data to be collected, providers to contact, and purpose of verification.

The orchestration engine 211 determines the execution order, processing independent categories in parallel while handling dependent categories sequentially. The system executes primary API calls to providers A, B, C, and others as configured for each category. Following data retrieval, the normalization engine 212 maps fields to the common schema, standardizes formats, and calculates match scores. The system then evaluates whether all required categories have been successfully verified.

If primary verification fails for any category, the workflow enters the multi-layer fallback system 205. The system first identifies which categories failed, then attempts Level 1 fallbacks using secondary APIs, alternative providers, different databases, or backup services. If unsuccessful, Level 2 fallbacks request document uploads such as pay stubs, tax documents, or official letters for OCR processing. If still unsuccessful, Level 3 fallbacks may initiate manual processes including contacting employers, calling institutions, or routing to human review.

Upon successful verification (whether through primary or fallback methods), the system applies composite scoring 206 (details in Composite Verification Scoring Methodology section 0039-0045) using weighted scores, confidence intervals, correlation factors, and reliability indices. After obtaining Tier 2 Consent 207, the normalized results are stored in the credential wallet with AES-256 encryption, user-specific isolation, and score recording. All events throughout this process are recorded in the audit log 208.

### Four-Tier Consent Management Architecture

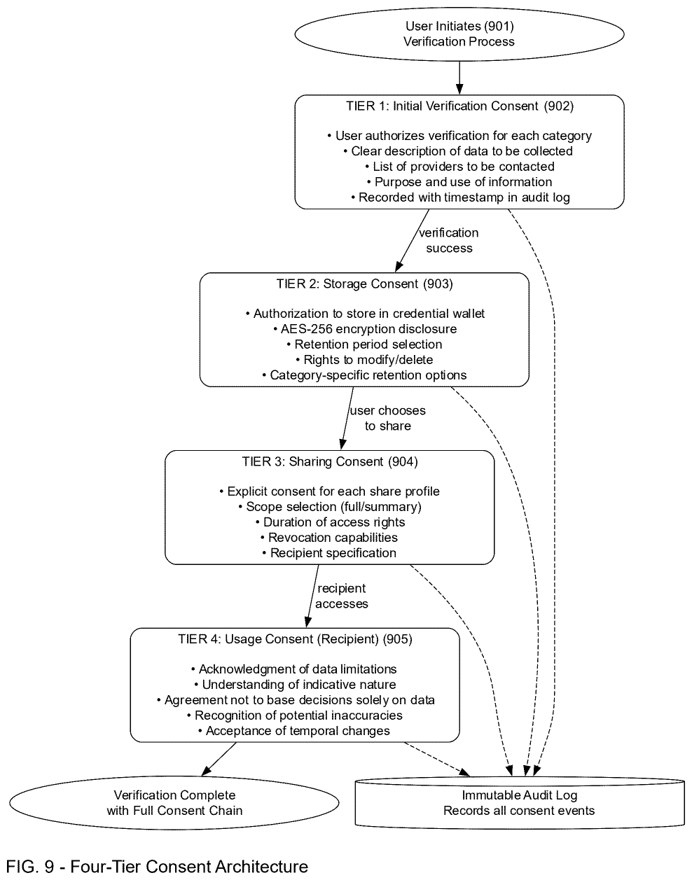

The invention implements a comprehensive four-tier consent management architecture as illustrated in FIG. 9, that exceeds typical privacy requirements and provides users with granular control throughout the verification and sharing lifecycle. This architecture demonstrates the invention's commitment to user autonomy and regulatory compliance without being tied to specific regulations that may change over time.

The Tier 1 Initial Verification Consent 902 requires explicit user authorization before initiating any verification category. The system presents clear descriptions of what data will be sought, which providers will be contacted, and how the information will be used. Users can provide category-specific consent, choosing to verify only certain aspects of their profile while declining others. This consent is recorded with timestamps and version information in the audit log.

The Tier 2 Storage Consent addresses 903 addresses the user's authorization to store verified data in their credential wallet. Even after successful verification, users maintain the right to decide whether to retain the verified information. The system clearly indicates data retention periods, encryption methods (specifically AES-256 encryption at rest), and the user's ongoing rights to modify or delete stored data. Users can choose different retention periods for different categories, reflecting varying sensitivity levels.

The Tier 3 Sharing Consent 904 governs each instance of credential disclosure. When creating a share profile, users explicitly consent to share selected verification categories with specified recipients. This consent includes the scope of shared data (full details versus summary), the duration of access, and any special conditions. The sharing consent is dynamically revocable, allowing users to terminate access at any time.

The Tier 4 Usage Consent 905 represents a novel addition that protects both users and recipients. Before accessing shared credentials, recipients must acknowledge that verification data may contain inaccuracies due to limitations in public records, the possibility of identity fraud, or temporal changes since verification. Recipients must agree that the shared credentials are indicative only and should not be the sole basis for significant decisions. This consent layer protects all parties by setting appropriate expectations about the nature and limitations of verified data.

### User-Controlled Credential Wallet Implementation

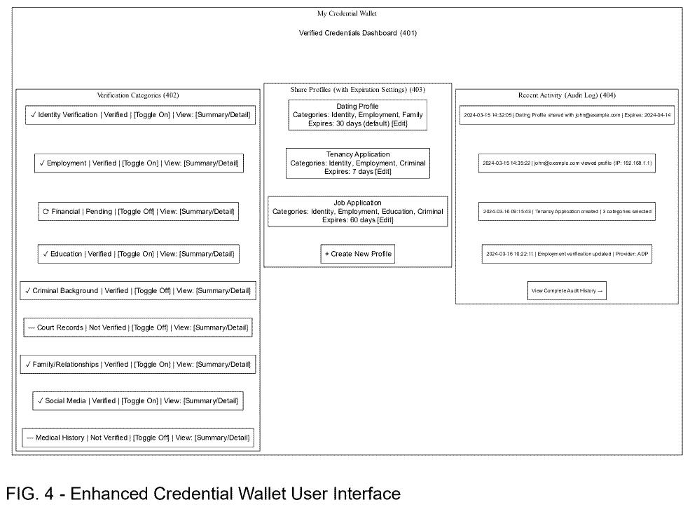

The credential wallet, as illustrated in FIG. 4 (Enhanced Credential Wallet User Interface), provides a comprehensive dashboard for managing verified credentials. The interface displays all verification categories 402 with visual status indicators: checkmarks (✓) for verified categories shown in green, rotating arrows ( [symbol] ) for pending verifications in yellow, and dashes (—) for unverified categories in gray. Each category row includes toggle controls for including/excluding from share profiles and view selectors for choosing between summary and detailed views.

The share profiles 403 section shows existing profiles with their configurations. For example, a “Dating Profile” might include Identity, Employment, and Family categories with a 30-day expiration (editable), while a “Tenancy Application” includes Identity, Employment, and Criminal categories with a 7-day expiration. Users can create new profiles with custom configurations for specific contexts.

The interface includes a recent activity 404 viewer showing timestamped audit log entries such as “2024-03-15 14:32:05|Dating Profile shared with john@example.com|Expires: 2024-04-14” and subsequent access events. This provides users with real-time visibility into how their shared credentials are being accessed, supporting the platform's transparency and user control principles.

### Context-Aware Selective Sharing Mechanism

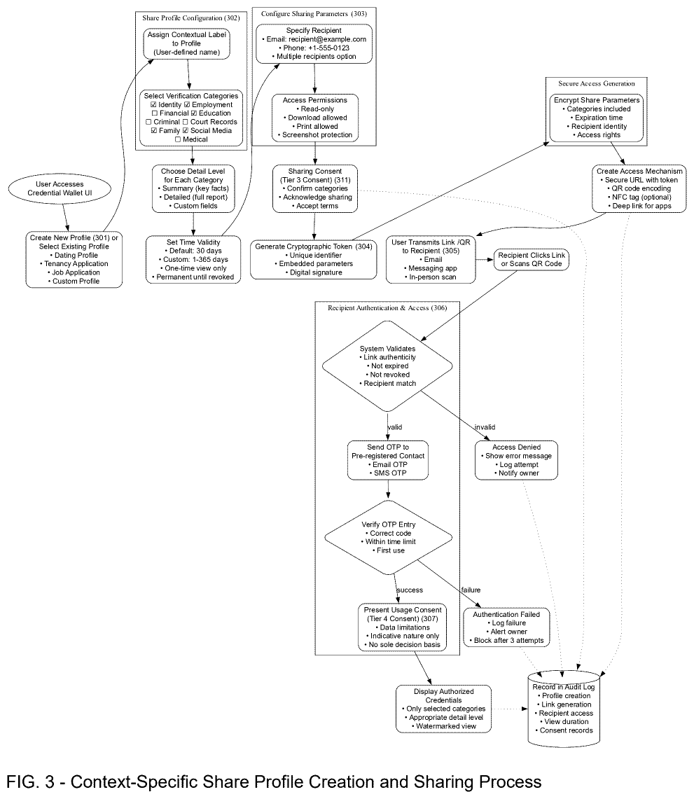

The invention implements a context-specific share profile creation and sharing process that enables users to create tailored disclosures for different purposes illustrated in FIG. 3. The process begins when a user accesses their credential wallet UI and either creates a new profile 301 or selects an existing one such as “Dating Profile,” “Tenancy Application,”“Job Application,”or a custom profile.

During share profile configuration 302, users assign a contextual label to the profile and select which verification categories to include. They can choose the detail level for each category-either summary (key facts), detailed (full report), or custom fields. Users then configure sharing parameters including time validity (default 30 days, custom 1-365 days, one-time view only, or permanent until revoked), recipient specification (email and phone number), and access permissions (read-only, download allowed, print allowed, screenshot protection).

After providing sharing consent (Tier 3 Consent) 311, the system generates a cryptographic token 304 with a unique identifier, embedded parameters, and digital signature. It then creates the access mechanism which can be a secure URL with token, QR code encoding, NFC tag (optional), or deep link for apps. The share parameters including categories included, expiration time, recipient identity, and access rights are encrypted within the mechanism.

When the recipient clicks the link or scans the QR code, the system validates link authenticity, expiration status, revocation status, and recipient match. If valid, it sends an OTP to the pre-registered contact method (email or SMS). After the recipient successfully enters the OTP (verified for correctness, time limit, and first use), the system presents the usage consent (Tier 4 Consent) explaining data limitations, indicative nature only, and that it should not be the sole basis for decisions. Only after accepting this consent can the recipient view the authorized credentials, which display only selected categories at the appropriate detail level in a watermarked view.

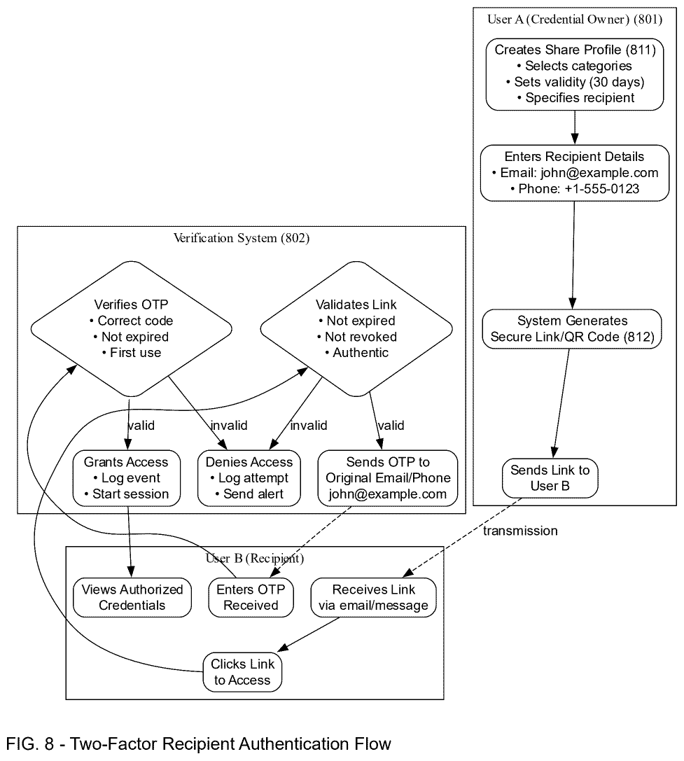

FIG. 8 details the two-factor recipient authentication flow. When User A creates a share profile 811, they specify the recipient's email and phone number. After the system generates a secure link or QR code 812, System and/or User A transmits it to User B. When User B clicks the link, the verification system 802 first validates that the link is not expired, not revoked, and authentic. If valid, it sends an OTP to the original email/phone specified by User A. Only after User B enters the correct OTP (verified for correctness, not expired, and first use) can they access the authorized credentials. Invalid links or failed OTP attempts result in access denial, logged attempts, and owner alerts, with blocking after three failed attempts.

All events are recorded in the audit log including profile creation, link generation, recipient access, view duration, and all consent records. Failed access attempts trigger appropriate responses: invalid links result in access denial with error messages, logged attempts, and owner notification; failed OTP authentication results in logged failures, owner alerts, and blocking after three attempts.

### Audit Logging System

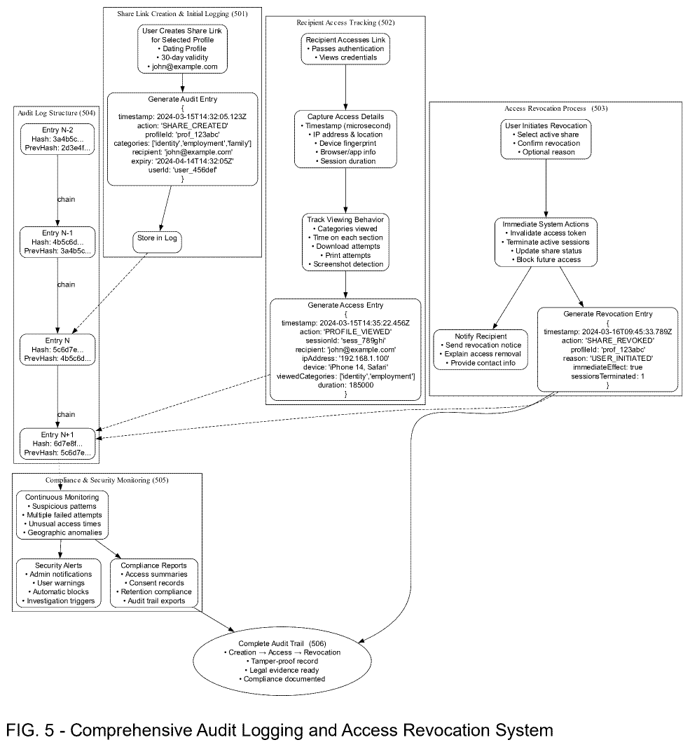

FIG. 5 illustrates the comprehensive audit logging and access revocation system that ensures complete tracking and user control. When a user creates a share link for a selected profile (e.g., Dating Profile with 30-day validity for john@example.com), the system generates a detailed audit entry containing timestamp, action type (‘SHARE_CREATED’), profile ID, included categories, recipient information, expiry date, and user ID.

When recipients access shared credentials, the system captures comprehensive details including timestamp, IP address and location, device fingerprint, browser/app information, and session duration. It tracks viewing behavior including which categories were viewed, time spent on each section, download attempts, print attempts, and screenshot detection. Each access generates a detailed entry with action type ‘PROFILE_VIEWED’ and all relevant metadata.

The revocation process provides immediate control. When a user initiates revocation, the system immediately invalidates the access token, terminates any active sessions, updates the share status, and blocks future access. It notifies the recipient about the revocation and generates a revocation entry with action type ‘SHARE_REVOKED’. The system also provides continuous monitoring for suspicious patterns, compliance reporting capabilities, and maintains the complete audit trail from creation through access to revocation, creating tamper-proof records suitable for legal evidence and compliance documentation.

### Technical Advantages and Industrial Applicability

The present invention provides numerous technical advantages over existing verification systems. The user-initiated and user-controlled nature fundamentally shifts the privacy and control paradigm, giving individuals ownership over their verified data. The multi-source verification with intelligent normalization significantly reduces false negatives while improving data accuracy. The context-aware sharing profiles enable appropriate disclosure for different use cases without requiring re-verification or over-disclosure of sensitive information.

The four-tier consent architecture provides legally robust protection for all parties while maintaining usability. The comprehensive audit logging creates transparency and accountability throughout the system. The automated fallback mechanisms ensure high verification success rates without sacrificing accuracy or security. The recipient authentication adds an additional security layer that prevents unauthorized access even if share links are intercepted.

While the invention has been described with reference to certain preferred embodiments, particularly in the context of dating platforms, it should be understood that the system has broad applicability across numerous domains. Employment screening, tenant verification, peer-to-peer marketplace transactions, financial service onboarding, healthcare provider credentialing, and professional networking all represent viable use cases. The modular architecture allows adaptation to domain-specific requirements while maintaining the core innovations of user control, selective disclosure, and comprehensive verification.

The system architecture supports various deployment models. In a centralized deployment, a single service provider operates the verification orchestration server and maintains the credential wallet database. In a federated model, multiple providers might operate compatible systems with interoperable credentials. Future embodiments might incorporate blockchain or distributed ledger technology for the audit log or credential storage, further enhancing tamper resistance and user control.

Those skilled in the art will recognize that numerous modifications and variations may be made without departing from the scope of the invention. Additional verification categories may be added, new external providers integrated, and alternative sharing mechanisms implemented. The specific technical choices described-such as AES-256 encryption, GraphQL for API communication, or 30-day default expiration periods-represent current preferred implementations but may be substituted with equivalent technologies. The essence of the invention lies in the novel combination of user-initiated comprehensive verification, normalized multi-source data aggregation, user-controlled persistent credential storage, context-aware selective sharing with recipient authentication, and comprehensive consent management with immutable blockchain like audit logging.

What is claimed is:

1. A computer-implemented method for user-controlled verification and selective sharing of personal credentials, comprising: receiving a user-initiated request to verify one or more personal credential categories; obtaining user consent for verification of each selected category; retrieving verification data from a plurality of external data sources; normalizing the verification data into a standardized format; storing the normalized verification data in a user-controlled credential wallet; receiving a request from the user to create a share profile specifying selected credentials to share; generating a secure access link for the share profile; and recording access events in an audit log when a recipient accesses the shared credentials.

2. The method of claim 1, wherein the personal credential categories comprise identity, employment, financial, education, criminal background, court records, family relationships, social media, and medical history.

3. The method of claim 1, further comprising: implementing a fallback verification process when primary verification fails, wherein the fallback process comprises attempting verification through an alternative data source.

4. The method of claim 1, wherein normalizing the verification data comprises: mapping data fields from different sources to a common schema; and standardizing data formats for dates, phone numbers, and addresses.

5. The method of claim 1, further comprising: authenticating a recipient before granting access to the shared credentials by sending a one-time password to a pre-registered contact method.

6. The method of claim 1, wherein the share profile comprises: selected credential categories; an expiration time for access; and recipient identification information.

7. The method of claim 1, further comprising: enabling the user to revoke access to the share profile, wherein revocation immediately prevents further recipient access.

8. The method of claim 1, further comprising: calculating a verification score for each credential category based on data source reliability and corroboration between multiple sources.

9. The method of claim 1, wherein obtaining user consent comprises: first consent for initiating verification; second consent for storing verified data; third consent for sharing data; and fourth consent from recipients acknowledging data limitations.

10. A system for user-controlled credential verification and sharing, comprising: a verification server configured to retrieve and process verification data from external sources; a credential wallet database for storing user-verified credentials; a share profile manager enabling users to select credentials for sharing; an access control module for generating secure share links and authenticating recipients; and an audit log for recording verification and sharing events.

11. The system of claim 10, wherein the verification server comprises: a workflow engine for coordinating verification across multiple categories; and a normalization engine for converting data from different sources into a common format.

12. The system of claim 10, wherein the access control module requires two-factor authentication before granting recipient access to shared credentials.

13. The system of claim 10, further comprising: a fallback module configured to attempt alternative verification methods when primary verification fails.

14. The system of claim 10, wherein the share profile manager enables creation of context-specific profiles for different sharing scenarios.

15. A method for progressive credential disclosure, comprising: creating a first share profile with basic credential categories; sharing the first profile with a recipient; creating a second share profile with additional credential categories; and sharing the second profile with the same recipient as trust develops.

16. The method of claim 15, wherein the basic credential categories comprise identity and employment verification, and the additional categories comprise financial and criminal background verification.

17. A method for ensuring verification data integrity, comprising: retrieving data from multiple verification sources; comparing data elements across sources; identifying discrepancies between sources; applying matching algorithms to resolve discrepancies; and generating a unified verification record with confidence scoring.

18. A non-transitory computer-readable medium storing instructions for: enabling user-initiated credential verification; storing verified credentials in a user-controlled repository; creating selective share profiles for different contexts; and tracking all verification and sharing activities in an immutable log.

19. The computer-readable medium of claim 18, further storing instructions for: implementing time-based access controls on shared credentials; and enabling immediate revocation of sharing permissions.

20. A method for context-specific credential sharing, comprising: maintaining a plurality of verified credentials for a user; receiving a selection of specific credentials to share based on context; generating a time-limited access mechanism for the selected credentials; requiring recipient authentication before granting access; and logging all access attempts and successful views for audit purposes.
